(19) United States
(12) Patent Application Publication
(10) Pub. No.: US 2022/0146107 A1
(43) Pub. Date: May 12, 2022

(54) PORTABLE MULTI-CAVITY MICROWAVE OVEN

(71) Applicant: Shuqing Li, North York (CA)

(72) Inventor: Shuqing Li, North York (CA)

(21) Appl. No.: 17/092,915

(22) Filed: Nov. 9, 2020

(51) Int. Cl. F24C 7/02; H05B 6/64; H05B 6/70

(52) U.S. Cl. CPC F24C 7/02; H05B 6/707; H05B 6/6402

(57) ABSTRACT

A portable microwave oven with waveguides for guiding microwave radiation in multiple directions to multiple oven cavities within a chamber to optimize the oven's space usage, efficiently distribute the usage of wave radiation energy, adjust cavity space to heat items with different shapes, sizes, and to adjust cooking parameters including power level and time. In one embodiment, two main side oven cavities are joined by a third oven cavity above. Dividers can be moved along the walls of their respective main side cavity to allow the use of the shared cavity in between. A magnetron sends radio waves to two adjacent cavities via a single waveguide structure with multiple waveguide openings. Another embodiment has four cavities with compartments in-between surrounding a cylindrical-waveguide structure with multiple waveguide branches and a magnetron inside to allow microwaves to travel from the magnetron to the oven cavities.

### FIELD

The present disclosure is in the field of engineering, electrical engineering, electromagnetic radiation, microwave, radio frequency transmission, food heating, microwave oven, and especially, a battery-powered portable microwave oven with multiple cavities and a waveguide structure with multiple openings and/or branches.

### BACKGROUND

Microwave ovens generate high-frequency microwave energy, typically at around a frequency of 2.45 GHz, via a microwave tube. The tube can be a klystron, magnetron, or traveling wave tube; hereinafter, only magnetron is referred to in the present disclosure. There are many cavities inside the magnetron, which are resonators consisting of a closed (or largely closed) metal structure, aka heating/cooking chamber, that confines electromagnetic fields in the microwave region of the spectrum. The microwaves bounce back and forth between the walls of the cavities. At the cavity's resonant frequencies, the microwaves reinforce to form standing waves in the cavity. This microwave radiation is then transmitted from an antenna and travels through a waveguide to a chamber cavity inside the oven's cooking chamber. A microwave waveguide is a structure that guides waves, such as electromagnetic waves or sound, with minimal loss of energy by restricting the transmission of energy to one direction. Microwave energy permeates the food and causes its water molecules to vibrate and produce thermal energy. This type of heating is called dielectric heating. In essence, the microwave oven is advantageous over other cooking methods because meals can be heated quickly, simultaneously, and uniformly.

However, there are some drawbacks with conventional microwave ovens: (1) they are large, heavy, and need AC power. Though existing battery-powered portable microwaves have been developed, they still have drawbacks like: (2) microwave ovens (both conventional and portable) usually have one single cavity in their cooking chamber. This means a lack of flexibility in chamber usage, operating times, and cooking abilities. For example, conventional microwaves do not have an option to set multiple cooking settings for heating several different foods at the same time. In such a case, one cannot simultaneously heat a glass of milk for a minute at 75% power, an egg for 10 seconds at 50% power, and a full-size pizza for two minutes at 100% power. Instead, food must be heated separately and sequentially. Hereinafter, the term food(s) is interchangeable with food item(s); (3) there is unused space near the magnetron area, leading to lower cooking space usage efficiency, which is especially disadvantageous for portable/personal use; (4) microwave radiation is distributed less efficiently in conventional microwave ovens. Waveguides in conventional microwave ovens only output microwaves generated by the magnetron in one direction. Hereinafter, the term waveguide on its own is interchangeable with waveguide structure. This means that a portion of the generated microwave energy will inevitably be wasted, which could cause the magnetron to heat up or even overheat. An improved microwave oven that can solve the above problems, improve the microwave oven's performance, especially to simultaneously cook different food items with various settings, and efficiently utilize cavity space is required.

The present disclosure provides new designs for a portable multi-cavity microwave oven with a waveguide with multiple openings or branches that guide microwave energy in multiple directions. The new designs improve upon existing portable microwave ovens by enabling: (1) heating different food items of different shapes and sizes simultaneously; (2) allowing multiple cooking setups and options; (3) using radiation energy from the magnetron source more efficiently; (4) incorporating a dynamic cavity space and power adjusting mechanism for flexible and optimized cavity space usage; where the latter two points, along with a few structural design considerations, further make the microwave oven more portable.

### SUMMARY

The present disclosure provides new designs for a portable microwave oven with a waveguide with multiple openings or branches that guide microwave radiation in multiple directions to multiple oven cavities in the oven's cooking chamber by putting a magnetron in the central location of the oven. The purpose is to do the following: efficiently distribute the microwave radiation energy; adjust power settings and cavity sizes for simultaneously cooking multiple food items with different sizes, shapes, timing, and cooking parameters; and optimally use the cavity space, or in other words, for the same cooking capability, the multi-cavity microwave oven of the present disclosure can be more portable.

Two main kinds of embodiments are discussed in the present disclosure. In the first kind, there are generally two or three cavities in the oven's cooking chamber. The first two are main side cavities, and the third is a partially shared cavity connecting or overlapping them above or below. Cavity dividers can be moved and adjusted to allow each cavity, separated or connected. The divider acts as a power switch when moved upwards to fully block microwave radiation from entering or adjusting the power level that enters the common cavity. A magnetron is connected to a waveguide with two openings, sending microwaves to the two main side cavities. The dividers can also be used to partially block the waveguide openings to form various microwave powers for different cooking needs. An angled protrusion is located on the top interior wall of the waveguide's interior surface facing downwards towards the magnetron; the protrusion ensures the microwave energy is guided into the chamber cavities from the waveguide openings. There is a myriad of various designs and arrangements of the three cooking cavities in this first kind of embodiment.

In the second kind of embodiment, there are multiple oven cooking cavities and the spaces between those cavities that are called compartments. The compartments can be used to store microwave components such as the control circuit, electrical components, spare battery, etc. The oven cooking cavities and compartments surround a cylindrical waveguide structure containing at least a magnetron in the center. The waveguide's radial orientation directs microwave energy from the magnetron to each of the oven cavities through the same number of waveguide branches. The top interior wall of the cylindrical waveguide structure has a conical protrusion pointing downwards towards the magnetron. Like in the first main kind of embodiment, the protrusion guides microwave energy to oven cavities via the waveguide branches. This cylindrical waveguide structure is rotatable so that the actual opening from the waveguide to a cooking cavity is adjustable, and the specific oven cavity receives a controlled amount of microwave energy through the connected waveguide branch. Instead of rotating the waveguide, a shutter may be used for adjusting the amount of microwave entering each oven cavity and the waveguide does not need to rotate. Such adjustments can then provide different cooking power, timing, and functions for different targeted oven cavities.

Another variant of the second kind of embodiment involves further modification to the cylindrical waveguide structure. First, the cylindrical waveguide does not rotate. Rather, shutters move along the cylindrical waveguide structure's outer diameter in a horizontal fashion to open or close the respective waveguide branches. This way, microwave energy entering particular oven cavities can be controlled. The cylindrical waveguide also has improved heat dissipation capability by connecting heats sink fins around the cylindrical waveguide structure below waveguide branches to chamber cavities. Each heat sink contains: a base plate attached to the cylindrical waveguide structure's length; a set of straight, rectangular thermal fins that extend and connect to the walls of the respective oven cavities. The design of the heat sinks provides increased thermal efficiency. More importantly, because the fins are connected to chamber cavity walls, the heat generated from the magnetron can transfer to the oven cavities via the thermal fins of the heat sink to reuse the previously wasted energy to heat the respective oven cavities. In other words, heat transfers from the cylindrical structure and encased magnetron to the oven cavities via the new thermal conduction paths. Additionally, at least a pair of fans facing the ends of the thermal fins is installed to blow off the heated air out of the microwave oven in a single direction. One fan blows air to dispel heat from the heat sinks, while another fan draws the heated air from the heat sinks out of the microwave oven. Thus, the efficiency of microwave energy usage and distribution can be further increased.

### BRIEF DESCRIPTION OF THE DRAWINGS

FIG. 1 illustrates a perspective view of a portable multi-cavity microwave oven in a preferred first kind of embodiment of the present disclosure.

FIGS. 2A-2C are perspective views of three door opening positions of a portable multi-cavity microwave oven in various exemplary first kind embodiments of the present disclosure.

FIGS. 3A-3C show a comparison of the cavity space efficiencies between a portable multi-cavity microwave oven in the preferred embodiment of the present disclosure and conventional prior arts, wherein FIG. 3A is a perspective view of an embodiment according to this disclosure and FIGS. 3B-3C are perspective views of microwave designs of the prior art.

FIGS. 4A-4B are perspective views and FIG. 4C is a top view of the portable multi-cavity microwave oven in a few second kind embodiments of the present disclosure.

FIGS. 5A-5B are perspective views of a preferred cylindrical waveguide/magnetron structure for the second main kind of embodiment of the present disclosure.

FIGS. 6A and 6C are front views of the waveguide structures of the embodiments shown in FIGS. 1 and 2A, respectively, and FIGS. 6B and 6D are top views of the waveguide structures shown in FIGS. 6A and 6C, respectively.

FIG. 7 illustrates a general operational flowchart for two preferred main kinds of embodiments of the portable multi-cavity microwave oven in the present disclosure.

FIG. 8 illustrates a general block diagram of the typical components for two preferred main kinds of embodiments of the portable multi-cavity microwave oven in the present disclosure.

### DETAILED DESCRIPTION

The language employed herein only describes particular embodiments; however, it is not intended to be limited to the specific embodiments of the disclosure. Within the disclosure, the term “and/or” includes any and all combinations of one or more associated items. Unless indicated, “a”, “an”, and “the” can encompass both the singular and plural forms within the disclosure. It should also be noted that “they”, “he/she”, or “he or she” are used interchangeably because “they”, “them”, or “their” are now considered singular gender-neutral pronouns. The terms “comprises” and/or “comprising” in this specification should specify the presence of stated features, steps, operations, elements, and/or components; however, they do not exclude the presence or addition of other features, steps, operations, elements, components, and/or groups. Unless otherwise defined, all terminology used herein, including technical and scientific terms, have the same definition as what is commonly understood by one ordinarily skilled in the art, typically to whom this disclosure belongs. It will be further understood that terms, such as those defined in commonly used dictionaries, should be interpreted as having the same meaning as defined in the context of the relevant art and the present disclosure; such terms will not be construed in a romanticized or overly strict sense unless explicitly described herein. It should be understood that multiple techniques and steps are disclosed in the description, each with their own individual benefit. Each technique or step can also be utilized in conjunction with a single, multiple, or all of the other disclosed techniques or steps. For clarity, the description will avoid repeating each possible combination of the steps unnecessarily. Nonetheless, it should be understood that such combinations are within the scope of the disclosure and the claims.

In the following description, specific details are mentioned to give a complete understanding of the present disclosure. However, it may likely be evident to one ordinarily skilled in the art; hence, the present disclosure may be applied without the mention of these specific details. The present disclosure is represented as one realization; however, the disclosure is not necessarily limited to the specific embodiments illustrated by the figures or description below. The description of the present disclosure will now be interpreted by specifying the appended figures representing preferred or alternative embodiments.

The present disclosure provides designs for a new portable microwave oven with multiple cavity configuration abilities using a single waveguide structure with multiple openings that guide microwave radiation in multiple directions to each oven cavity. Each cavity is formed from a specific division of the oven's overall cooking chamber. The designs include a number of embodiments related to form factor, number and arrangement of cavities, oven door opening options, use of movable dividers to adjust the microwave energy distribution, and attachment of compartmentalized components (e.g., battery, control circuit, etc.). While more variations are shown, the present disclosure mainly revolves around two kinds of embodiments.

In the first main kind of embodiment, the microwave oven's cooking chamber contains two or three standard cooking cavities: two main side vertical oven cavities that are joined by a third horizontal oven cavity. Hereinafter, the term main side oven cavity is interchangeable with the main side cavity, side cavity, main cavity, or vertical cavity. The middle section contains a magnetron and a waveguide structure with two waveguide openings that send microwaves to the two adjacent side cavities. Two side walls enclose the magnetron in the chamber center, and two movable dividers can be moved along the walls to allow the two side cavities to access a partially shared cavity between them. Hereinafter, the term movable divider is interchangeable with divider, adjustable divider, and dynamic divider. If both dividers are fully open, all three cavities become fully connected as if there is only one U-shaped (or N-shaped) cavity; it occupies the full cooking chamber. If one divider is open and another is closed, the microwave oven works with two cavities—one is L-shaped, and the other is cube-shaped. If both dividers are closed, three independent cavities are formed—two on the sides and one in the middle between the two side cavities. Each cavity can cook a different sized food item with a different cooking power and timing simultaneously. In order to have even more flexibility in cooking food items simultaneously, the second main kind of embodiment contains four oven cavities with spaces in between for attachable compartments. The compartments attach microwave components that contribute to the microwave functions, including the control circuit, human-machine interface, electrical components, backup batteries, etc. Four waveguide branches, connected by a cylindrical waveguide structure, direct microwaves from the magnetron to each oven cavity.

The new designs address several issues presented in the existing designs that have a single cooking chamber. In a first aspect of the present disclosure, a portion of cavity space is always wasted in conventional and prior-art microwave ovens. The magnetron or microwave tube typically occupies one full side of the microwave oven cooking chamber. Actually, after the magnetron is installed, it does not take up the entire blocked-out space. Given the shape of conventional microwave oven cavities (as a rectangular prism or a cube), this leaves unused space in the area around the magnetron. However, this space cannot be used to place different food items in the oven cavity. The microwave oven designs in the present disclosure utilize this space by implementing smaller multiple connectable oven cavities, as well as rearranging the magnetron and waveguide(s), battery, and other electrical components. In particular, the magnetron is moved to the center, while the other components are moved to areas outside of potential cavity space, such as the bottom of the microwave oven. The waveguides in the present disclosure are also designed in a way that frees up unused space. Naturally, these designs increase the amount of usable oven cavity space in the chamber.

In a second aspect of the present disclosure, conventional microwave ovens use a single waveguide to transport microwave energy in one direction. Since microwave radiation is omnidirectional, a large amount of energy will be dispersed within the magnetron surroundings, which bounce back to the magnetron and interior walls of the waveguide in other directions. Each bouncing absorbs a small portion of microwave energy. This reflection of microwaves is not only a waste of energy, it also generates heat. The portable microwave oven in the present disclosure increases the usage efficiency of microwave energy distribution by incorporating multiple waveguide openings (the first kind of embodiment) or branches (the second kind of embodiment) through one waveguide structure. This gives microwaves an additional outlet to disperse. The designs effectively decrease the wasteful energy reflection and heat generation around the magnetron; therefore, it improves energy usage efficiency. The waveguide structure in both main kinds of embodiments also contains a protrusion at the top of the waveguide structure's interior. This protrusion reflects microwave energy into the waveguide, prevents it from bouncing back to the magnetron.

In yet another embodiment related to the second main kind of microwave oven embodiment, the cylindrical waveguide structure has heats sink fins around the cylindrical waveguide structure below waveguide branches to chamber cavities. Each heat sink contains: a base plate attached to the cylindrical waveguide structure's length; a set of straight, rectangular thermal fins that extend and connect to the shells of the respective oven cavities. The connection can be made by soldering two metal pieces together. The design of the heat sinks provides increased thermal efficiency. More importantly, because the fins are connected to chamber cavity walls, the heat generated from a magnetron can transfer to the oven cavities via the thermal fins of the heat sink to reuse the previously wasted energy to heat the respective oven cavities. In other words, heat transfers from the cylindrical structure and encased magnetron to the oven cavities via the new thermal conduction paths.

Additionally, at least a pair of fans facing the ends of the thermal fins is installed to blow off the heated air out of the microwave oven in a single direction. One fan blows air to dispel heat from the heat sinks, while another fan draws the heated air from the heat sinks out of the microwave oven. Thus, the efficiency of microwave energy usage and distribution can be further increased. Hereinafter, the fans in this waveguide embodiment are known as blowing fan and suction fan, respectively. This alternative embodiment of the cylindrical waveguide structure allows more microwaves to be used without significantly increasing the ambient temperature.

In a third aspect of the present disclosure, conventional microwave ovens have a single oven cavity inside the cooking chamber, which cannot be adjusted to heat different food items. Other existing microwave ovens incorporate a horizontal divider to create multiple cavities to heat separate food items simultaneously. However, these cannot be flexibly adjusted to accommodate differences in number, dimensions, connectivity of cavities, and cooking parameters like time, power level, and starting time. The microwave oven in the present disclosure, particularly the first main kind of embodiment, can heat different types of food items using different cavities and movable dividers along the cavities' walls. These dividers provide access to a different oven cavity. Prior to the oven's operation, the dividers can be moved downwards to provide this access. With these dividers' adjustment, users can determine when to start cooking and which cavities are suitable for which food. As a result, the microwave oven in the first main kind of embodiment can accommodate a wide variety of food items for simultaneous heating to save the overall cooking time. Simultaneous cooking can also improve the overall energy usage efficiency.

In a fourth aspect of the present disclosure, there is a need to properly cook different types of foods using different duration, power settings, and other cooking options. The portable microwave oven in the first main kind of embodiment addresses this need by adjusting the movable dividers to partially block the third oven cavity from receiving microwave power. Once the divider fully blocks the third cavity, the cooking time and power level for the separated third cavity are set at zero. Alternatively, the movable dividers can stop at the waveguide opening level to prevent microwave energy from entering a main side cavity. In the second main kind of embodiment, this is addressed with a cylindrical waveguide structure that rotates along a fixed circular band to match the waveguide structure's openings to with the rear openings of the waveguide branches. In a sense, this rotation can be used to cut off certain cavities from receiving microwave energy. In another variant of this kind of embodiment, shutters move horizontally along a transverse plane to open or close a waveguide branch and its respective cavity. The dividers in the first main kind of embodiment and cylindrical structure's rotated position in the second main kind of embodiment can also act as an energy power attenuator when moved halfway with a partial opening by a certain percentage to adjust the amount of microwave energy entering the other cavity; therefore, the cooking power is controlled. When a divider is fully closed or an opening of the cylindrical structure is cut off, the cooking in the controlled cavity ends.

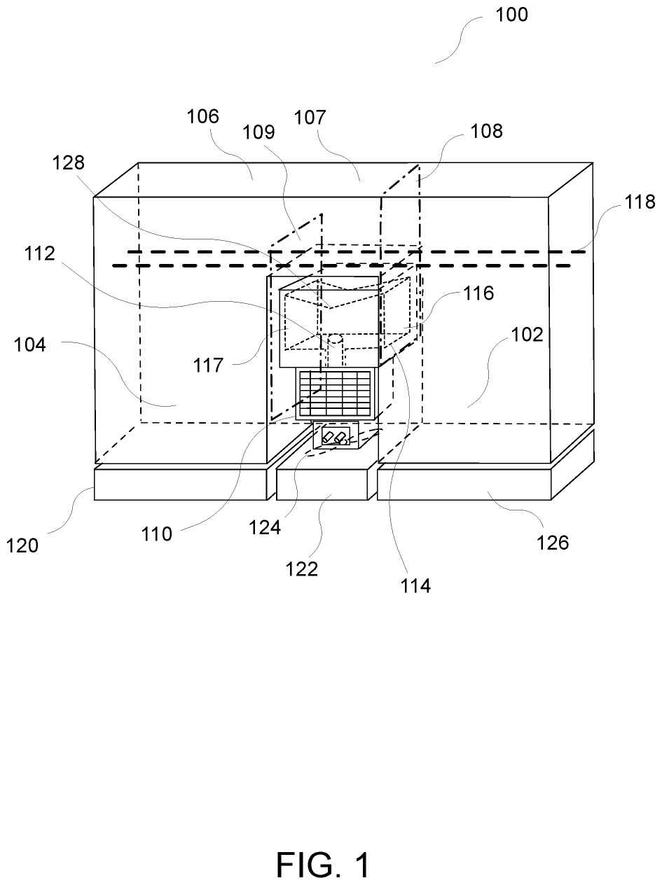

FIG. 1 illustrates a perspective view of a portable multi-cavity microwave oven in a preferred first kind of embodiment of the present disclosure. The preferred embodiment (100) comprises a first main side oven cavity (102) that is from the very top to the bottom on one side of the oven (100); and a second main side oven cavity (104) that is from the very top to the bottom on the other side of the oven (100). Both main side cavities (102, 104) share a third horizontal cavity (106), which occupies the entire top or bottom space of the oven cooking chamber. The center portion (107) is a space in the third cavity (106) that is not shared with the first or second side cavity (102, 104). This center portion (107) is hereinafter called center cavity (107). An inner adjustable divider (108) is used to separate the first side cavity (102) and the center cavity (107). Besides spatially disjoint, the separation here also means separation thermally and/or electrically insulation. Another inner adjustable divider (109) is used to separate the second side cavity (104) and the center cavity (107). Both dividers (108, 109) are located on the inner side walls of both the first (102) and second (104) main side cavities. A magnetron (110) and waveguide structure (114) are located between the two main side cavities (102, 104). The first side cavity's (102) inner side wall separates the magnetron (110) from the first side cavity (102). The second side cavity's (104) inner side wall separates the magnetron (110) from the second side cavity (104). The waveguide structure (114) consists of two waveguide openings (116, 117) combined together. An antenna (112) on the magnetron (110) transmits microwave radiation through the waveguide structure (114) to the side oven cavities (102, 104) via adjacent waveguide openings (116, 117). The waveguide opening (116) allows microwave energy to travel from the magnetron antenna (112) to the first side cavity (102). The waveguide opening (117) allows microwave energy to travel from the magnetron antenna (112) to the second side cavity (104). A protrusion with rectangular faces angled downwards, also known as the angled protrusion (128), is found at the top of the waveguide structure's (114) interior. A bar rack (118) sits at the bottom of the third oven cavity (106). The bar rack (118) can be one or multiple rigid wires. The bar rack (118) is used to hold the food to be cooked without completely separating the two cavities. The bar rack (118) should be made of any material that is not electrically conductive so that the microwave radiation can pass through. At least a battery (120) is used to power the entire microwave oven (100). The battery (120) can be stored and connected at the bottom of the second main side cavity (104). A cooling unit (122), including a cooling fan (124) and/or heat sink, may be located underneath the magnetron (110). A component, known as the power supply and control circuit/unit (126), may be connected to the bottom of the first main side cavity (102). The battery (120) and control unit (126) may also switch their locations under the microwave oven (100).

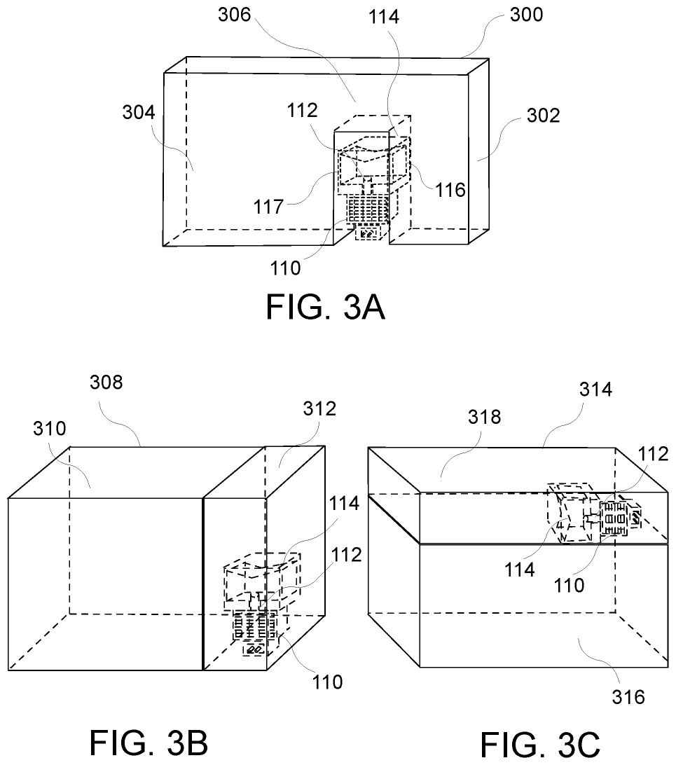

It should be noted that the first (102), second (104), and third (106) oven cavities and their relative positions and sizes described above are only for exemplary purposes; other obvious variants are also possible in the design. The mechanism to form the base of the third cavity (106) is not limited to using bars or wires. A movable divider can also be used to separate the shared portions from the first and second side cavities (102, 104). In an alternative embodiment of the present disclosure, the entire chamber structure can be rotated by 90 degrees clockwise or counter-clockwise, so the shared cavity (106) can be vertical, and the previous two side cavities (102, 104) can now become horizontal. The size and volume of the first (102) and second (104) main side oven cavities are shown to be equal in the preferred embodiment (100). In another exemplary embodiment, the size and volume of these two cavities (102, 104) can be different to fit particular foods of a particular shape and size. Such an embodiment may be required when fitting a particular food item; it may also be the manufacturer's decision. However, the volume of total usable space is still the same as in FIG. 1. This will be explained in discussion below about FIGS. 3A-3C.

The cavities' (102, 104, 106, 107) internal walls act as a metal Faraday cage, which traps microwaves within an enclosure. The microwave radiation then bounces around inside the cavity (102, 104, 106, 107) space. The cavity (102, 104, 106, 107) walls of the portable microwave oven (100) can be made of metal or a metal-coated plastic material. The cavity (102, 104, 106, 107) walls can either be a single piece or multiple pieces that are welded, press-fitted, or bolted together. In another embodiment, the cavity (102, 104, 106, 107) walls can be insulated to reduce heat loss further.

The adjustable dividers (108, 109) are key to simultaneously heating different food items and adjusting the power level and cooking time of the horizontal oven cavity (106). When the dividers (108, 109) are all moved downwards completely under the bar rack (118), all cavities (102, 104, 106, 107) are fully connected and exposed to microwave radiation. As a result, the two main side cavities (102, 104) use the additional space from the shared cavity (106) to accommodate additional food items. As the dividers (108, 109) both move upwards to a certain extent, they become filters that block the microwave energy entering the center oven cavity (107). When both dividers (108, 109) are moved fully upwards and separate the cavities (102, 104, 106, 107) completely, each main side oven cavity (102, 104) would then be its own Faraday cage. If one divider (108, 109) is fully closed and another is partially or fully open, the center cavity (107) only receives energy from one of the side oven cavities (102 or 104). The dividers' (108, 109) movement can be controlled manually or automatically using programmed motors. Alternatively, the dividers (108, 109) can be used to shut off one or both waveguide openings (116, 117). When the waveguide opening (116) is closed by the divider (108), any cavity (102, 104, 106, 107) can only get microwave power from the waveguide opening (117). When the divider (109) closes the waveguide opening (117), any cavity (102, 104, 106, 107) can only get microwave power from the waveguide opening (116). This flexibility allows the user to select one or multiple cavities (102, 104, 106, 107) to heat food.

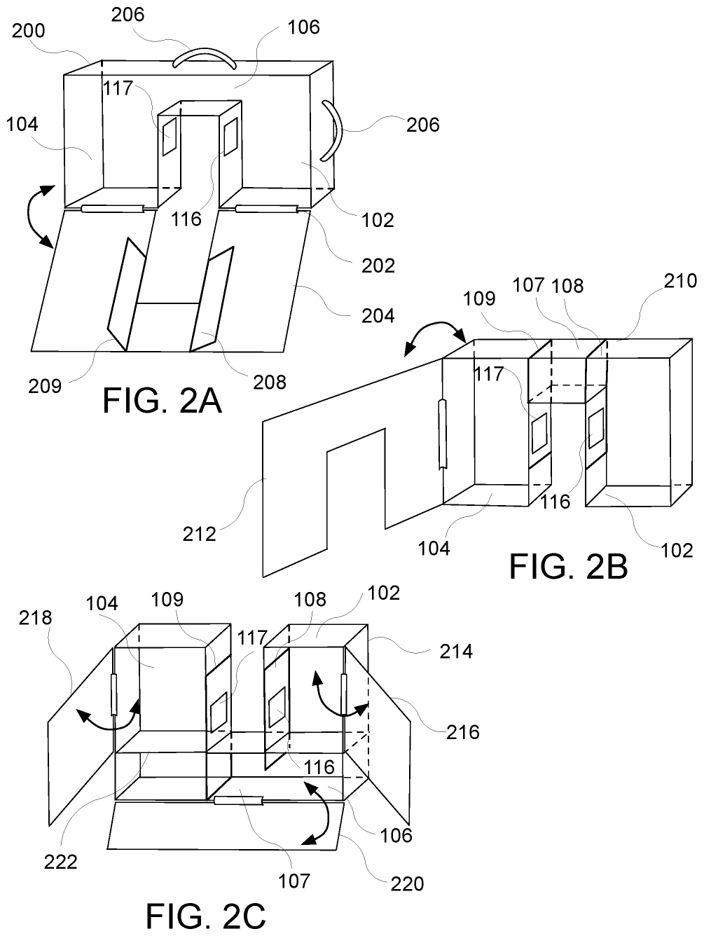

The bar rack (118) is considered an optional component that is detachable or permanently implemented at the base of the third oven cavity (106). The bar rack (118) can address the need for heating differently sized food items. For example, the bar rack (118) can be used for heating flat and large foods like a pizza slice or a batch of sausages. At the same time, the first side cavity (102) can be used to heat a glass of milk, while the second side cavity (104) can be used to heat a large bag of fries. The cooking efficiency is improved since the cooking time is minimized and the microwave energy is more efficiently used. The detailed reason will be further explained in the later paragraphs and figures. The bar rack (118) can be implemented with the dynamic dividers (108, 109) passing through the bar rack (118); this will also be demonstrated in FIGS. 2A-2C. In doing so, food items can be placed in the third cavity (106) or center cavity (107). As a result, it increases the flexibility of heating different food items in the cavity (102, 104, 106, 107) space of the microwave oven (100). It should be noted that the bar rack (118) should not be made out of metal or ferrite.

In an alternative embodiment, individual horizontal dividers can be placed in the middle of the first (102) and/or second (104) main cavities. This allows even further compartmentalization to heat food simultaneously. However, these horizontal dividers would be fixed in place within the side cavities (102, 104), limiting the flexibility in the types of food items placed inside. These horizontal dividers may also filter microwave energy from reaching the blocked spaces within the two main side cavities (102, 104). As a result, additional waveguide structures (114) and waveguide openings (116, 117), linked to the magnetron (110), would be required to heat those cavity (102, 104) sections properly.

An additional magnetron (110) can be installed in another exemplary embodiment to further allow custom power level and cooking time adjustment for each cavity (102, 104, 106, 107). However, the power supply and control circuit (126) would need to be modified to handle sending additional electrical power to multiple magnetrons (110). The control circuit (126) may also include a power converter and other associated components. In yet another embodiment, circulation fans or stirrers can be used to circulate and make the hot air or microwave more uniform throughout the cavities (102, 104, 106, 107) to ensure even cooking of food. Alternatively, turntables can be implemented at the base of the side cavities (102, 104) to turn the food during cooking. As the turntable rotates food, it can promote uniform cooking in all directions. However, additional components would be required, which would take up space and affect the compact design of the portable microwave oven (100).

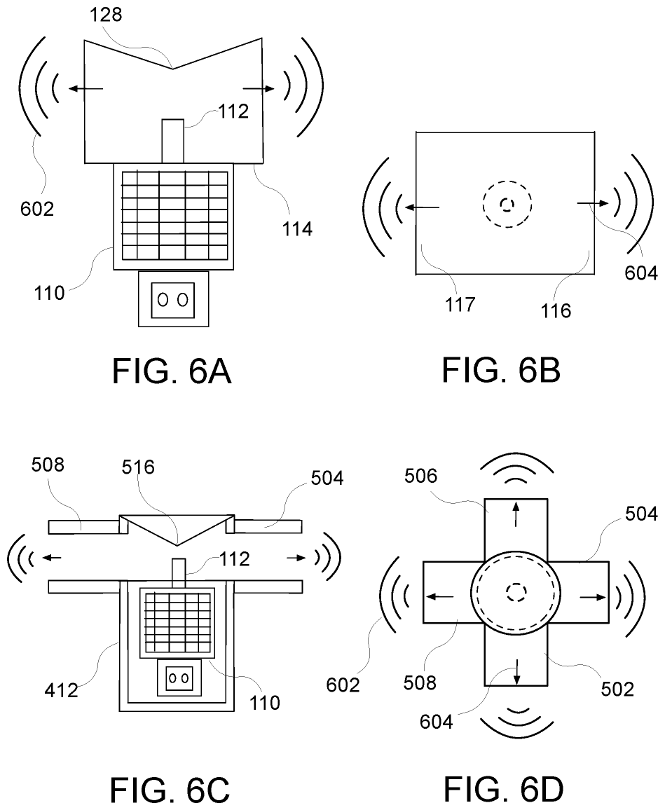

Two waveguide openings (116, 117) are linked together as one waveguide structure (114) on top of the magnetron (110), as shown in this figure. Each waveguide opening (116, 117) aligns with an adjacent main side oven cavity (102, 104). The antenna (112) at the center transmits microwave radiation through the waveguide structure (114) and openings (116 117) to the respective oven cavities (102, 104). As a result, the microwaves can reach all the cavities (102, 104, 106, 107). The shape of the waveguide openings (116, 117) is shown to be rectangular in FIG. 1. In other embodiments, the waveguide openings (116, 117) can be of a different shape, including circular, elliptical, rhomboid, etc. However, they must ultimately configure to the shape of the associated waveguide structure (114) and the openings of the respective oven cavities (102, 104). The angled protrusion (128) at the top of the waveguide structure (114) helps guide microwave energy to the waveguide openings (116, 117) and, in a sense, act as a sort of divider between the two waveguide openings (116, 117). This will be explained later in the paragraphs below and in FIGS. 6A-6D.

In yet another embodiment, the waveguide openings (116, 117) can be covered with a waveguide cover that is made of a non-conductive and non-magnetic material. This cover typically protects electrical components from condensation from generated steam during cooking. Although the electrical components in the present disclosure are moved to the bottom of the side oven cavities (102, 104), splashes and debits of food may still reach the magnetron (110) during cooking. Therefore, a waveguide cover in the present disclosure could prevent such an occurrence to ensure the consistent operation of the microwave oven (100).

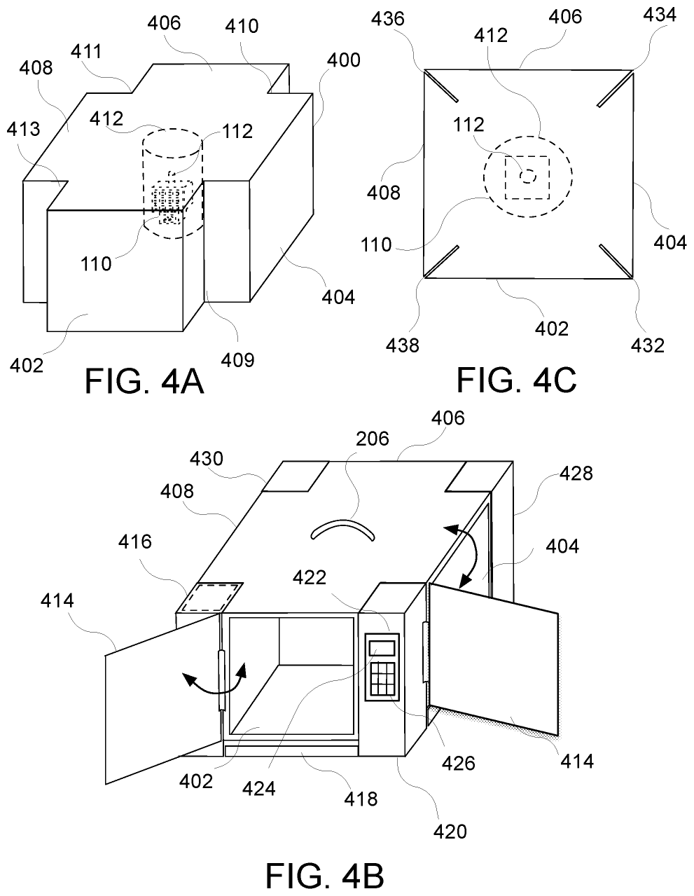

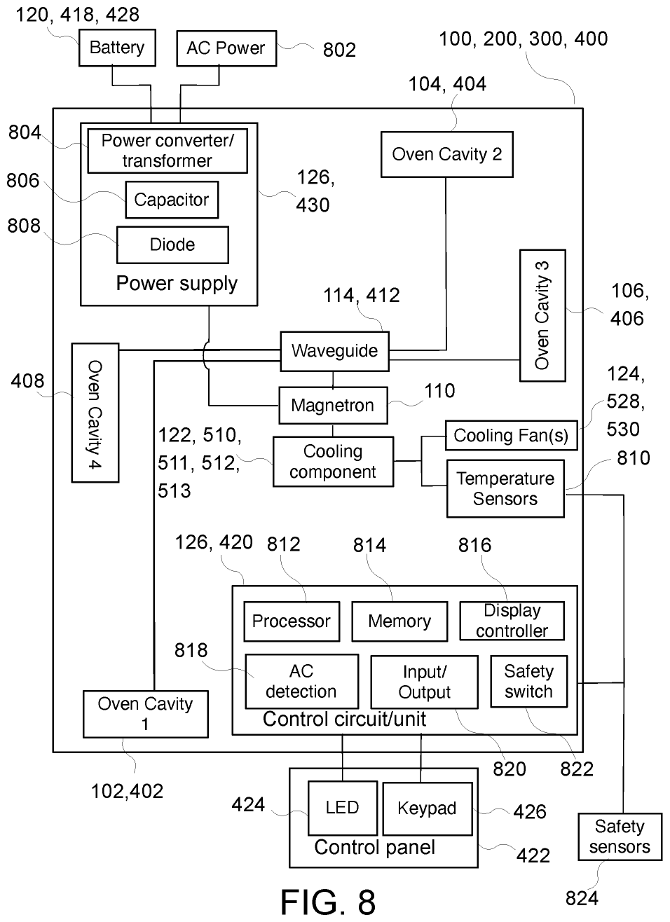

In some embodiments of the present disclosure, the battery (120) used to power the microwave oven (100) is a removable lithium-ion battery that can be swapped out for charging or with another charged battery (120). The battery (120) can also be charged in the microwave oven (100) if the oven (100) is plugged in. In other embodiments, multiple batteries (120) can be used; this will be explained in the paragraphs below and in FIGS. 4A-4C. It should also be noted that the power supply and control circuit (126) are integrated as one component in this kind of embodiment. However, the power supply and control circuit/unit (126) would comprise separate components within one compartment body that holds them together. The power supply gets a voltage from an external source and converts it for the magnetron (110) to use. The control circuit/unit refers to the components that act as a ‘computer’ to process information and communicate with the other components. This will be explained in future paragraphs and in FIG. 8. Hereinafter, the term control circuit is interchangeable with control unit.

FIG. 2A illustrates one exemplary embodiment of a portable multi-cavity microwave oven with the front oven door fully opened. FIG. 2A is regarded as a microwave oven design in the second embodiment (200). All descriptions of the portable microwave oven in FIG. 1 also apply here. Additionally, the portable microwave oven (200) is designed as a portable box with carrying handles (206) at the top and/or side of the oven (200). The portable microwave oven in the second embodiment (200) is shown to have a double-hinged microwave enclosure door (204). In the microwave oven's (200) typical orientation, the double-hinged microwave enclosure door (204) opens in a downwards direction and closes in an upwards direction along the pivot axes of its hinges (202), which are located at the bottom of the two main side cavities (102, 104). Hereinafter, the term enclosure door can be interchangeable with door, oven door, and microwave door. The door (204) seals all the cavities (102, 104, 106, 107). The door (204) also has two hinged cavity dividers (208, 209) located vertically along the interior edges of the door (204), which can turn along its pivot axis to cover and block the center oven cavity (107).

The hinged dividers (208, 209) work in the same way as the movable dividers (108, 109) described previously in FIG. 1. When the double-hinged door (204) is open, the hinged divider (208) can be swung upwards and then separate the center oven cavity (107) from the first side cavity (102) as the door (204) closes. Similarly, the hinged divider (209) can be swung upwards and then separate the center oven cavity (107) from the second side cavity (104) as the door (204) closes. One or both hinged dividers (208, 209) can be used to adjust the power level and cooking time of a particular cavity (102, 104, 107) as they are partially open or closed. In an exemplary embodiment, the hinged dividers (208, 209) can slide along the interior edges of the door (204) for further adjustments to cavity (102, 104, 107) space. In yet another exemplary embodiment, the hinged dividers (208, 209) can be replaced with the typical movable dividers (108, 109) along the interior walls of the first (102) and second (104) main side cavities. In both exemplary embodiments, the dividers (108, 109, 208, 209) can be situated at the level of the waveguide opening (116, 117) to prevent microwave energy from entering an adjacent main side cavity (102, 104). This essentially cuts the cooking time and power level of a main side cavity (102, 104) to zero.

FIG. 2B illustrates another exemplary embodiment of a portable multi-cavity microwave oven with the front oven door fully opened from one of the sides. FIG. 2B is regarded as a microwave oven design in the third embodiment (210). All descriptions of the portable microwave oven from FIG. 1 also apply here. The portable microwave oven in the third embodiment (210) has a hinge (202) adjacent to the second main side oven cavity (104), which rotates a single-hinged microwave enclosure door (212) to open outwards and close inwards along its vertical pivot axis to seal the entire microwave oven (210), as shown in the sub-figure. Movable dividers (108, 109) are located along the inner walls of the first (102) and second (104) main oven cavities, or vertically along the interior edges of the door (212), and work in a similar way as the dividers (208, 209) in FIG. 2A. When both dividers (108, 109) are closed, the center cavity (107) receives no microwave energy at all. However, this scenario is commonly avoided because the magnetron will overheat, causing a safety concern. The third embodiment (210) falls back to have only two cavities (102, 104). The different cooking times for each of the two cavities (102,104) can be implemented as a timely closing up of the waveguide openings (116, 117) via the movement of the dividers (108, 109). For example, use a timer to control the waveguide opening (116) to open for two minutes. After two minutes have passed, a manual or automatic mechanism will close the opening (116) to stop the cooking operation.

FIG. 2C illustrates another exemplary embodiment of a portable multi-cavity microwave oven with three separate front oven doors fully opened. This exemplary embodiment is regarded as a microwave oven in the fourth embodiment (214). It should be noted that the microwave oven in the fourth embodiment (214) is shown with a horizontal cavity (106) and an associated center cavity (107) at the bottom of the oven (214); the cavities (102, 104, 106, 107) listed in this sub-figure are in line with the typical orientation, as are the previous sub-figures. Each cavity (102, 104, 106, 107) has its own door: a first oven cavity door (216) seals the first main side oven cavity (102), which opens outwards and closes inwards in the directions (directional arrows), as shown in the sub-figure; a second oven cavity door (218) seals the second main side oven cavity (104), which opens outwards and closes inwards in the directions (directional arrows) shown the sub-figure; a third oven cavity door (220) seals the third horizontal oven cavity (106) and its associated center cavity (107), which opens outwards and closes inwards in the directions (directional arrows) shown the sub-figure. In this embodiment, a movable horizontal divider (222) is located between the third oven cavity (106) and the first and second side cavities (102, 104). The sub-figure also shows the dynamic dividers (108, 109) alongside the movable horizontal divider (222).

Like with the hinged dividers (208, 209) in FIG. 2A, the movable horizontal divider (222) functions similarly to the dynamic dividers (108, 109) in that it blocks microwave radiation from reaching the third oven cavity (106) and the associated center cavity (107), even when the movable horizontal diver (222) leaves a half-open space. The movable horizontal divider (222) contains multiple sections; the sections above the main side cavities (102, 104) would move inwards to allow microwave energy to heat food in the shared oven cavity (106) and the associated center oven cavity (107). In another scenario, part of the movable horizontal divider (222) can isolate one of the main cavities (102, 104), while another main cavity (102, 104) is heated alongside the shared oven cavity (106) and the associated center oven cavity (107). This addresses the need to adjust the cavity (102, 104, 106, 107) spaces for heating different food items simultaneously.

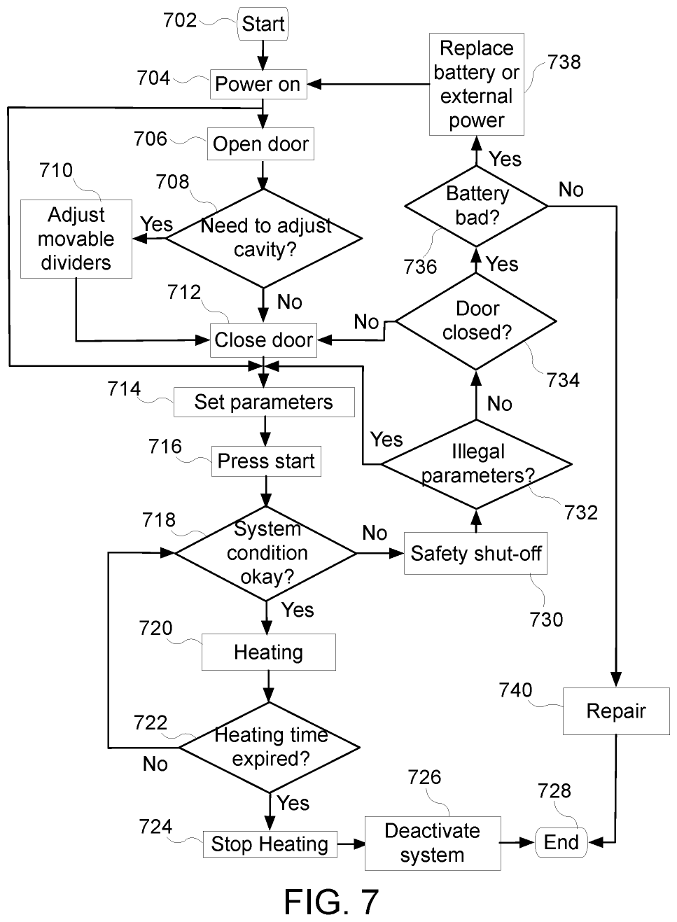

All the doors (204, 212, 216, 218, 220) illustrated in the second (200), third (210), and fourth (214) embodiments are securely held in place with a door lock when fully closed. Keeping the door (204, 212, 216, 218, 220) closed is key to safely operating the portable microwave oven (200, 210, 214). This seal also keeps microwave radiation within the cavities (102, 104, 106, 107). If the doors (204, 212, 216, 218, 220) are not completely closed, a safety switch will be activated to prevent the microwave oven (200, 210, 214) from operating. This will be further explained in future paragraphs and in FIGS. 7 and 8.

The handles (206) can be in a fixed position, as shown in FIG. 2A. The handles (206) may also be installed on the oven described in FIGS. 2B and 2C. In other embodiments, the handles (206) can rotate along a pivot axis on the side of the attachment. Doing so can save space for better portability and prevent pinching when handling the portable microwave oven (200, 210, 214). The hinges (202) can be located internally or externally of the microwave oven (200, 210, 214) outer body. While typically a design choice, having the hinges (202) inside the outer body is preferred for most microwave ovens (200, 210, 214) due to having protection from shock or impact.

FIG. 2C also illustrates that the portable microwave oven (214) can be positioned on a different orientation. All other combinations of the features, location or positions of dividers (108, 109, 208, 209, 222), doors (204, 212, 216, 218, 220), openings, and operating orders in the descriptions of FIGS. 2A, 2B, and 2C should be considered obvious to those ordinarily skilled in the art. Safety sensors determine the operation of the portable microwave oven (214) within the control circuit; this will be explained further in future paragraphs and in FIG. 8.

FIGS. 3A-3C illustrate a comparison of the cavity space efficiencies between a portable multi-cavity microwave oven in the preferred embodiment of the present disclosure and conventional prior arts. FIG. 3A illustrates a preferred embodiment based on the first kind of embodiment with a different first and second side cavity sizes. This embodiment is identified as the fifth major embodiment (300). The components of the portable microwave oven in the fifth embodiment (300) are nearly identical to that of the portable microwave oven in FIG. 1. The description regarding the magnetron (110), antenna (112), waveguide (114), and waveguide openings (116, 117) all apply here. However, the first main side oven cavity from FIG. 1 has been modified into a new smaller size, shown as a modified first oven cavity (302). The second main side oven cavity from FIG. 1 has increased in size into a modified second oven cavity (304). The third oven cavity (306) is shown to be connected above the two main side cavities (302, 304).

The portable microwave oven in this fifth embodiment (300) is just one example of the cavity (302, 304, 306) sizes pertaining to the modified oven cavities (302, 304, 306). In fact, the modified oven cavities (302, 304, 306) can be manufactured at any size. Regardless of the modified oven cavity (302, 304, 306) sizes, the portable microwave oven (300) fully utilizes the extra space wasted with conventional microwave designs. Since the space that holds the magnetron (110) and waveguide (114) is a fixed size, the ratio of usable space to total volume is consistently higher than in conventional microwave designs. This will be shown with the following sub-figures. Additionally, the higher usable space ratio also contributes to the portable microwave oven's (300) capability to simultaneously heat different food items.

In an alternative embodiment, semiconductors or a solid-state microwave generator can be used to generate microwave energy for heating food in the microwave oven (300). These microwave generators can vary in frequency, which addresses any cold spots within the cavity (302, 304, 306) space and leads to more uniform cooking. Such components also last longer, are smaller, consume less power, and cook food more accurately. More importantly, the smaller size of the semiconductors or solid-state microwave generators could free up even more cavity (302, 304, 306) space and raise the usable space ratio even higher.

FIG. 3B illustrates an existing microwave design, also known as a first conventional microwave oven (308). The first microwave structure (308) has the exact same dimensions and total volume as the portable microwave oven (300) in FIG. 3A. The first conventional microwave oven (308) contains a usable cavity space (310) only on one side and an adjacent section containing the magnetron (110), antenna (112), waveguide (114), and control electronics. The entire space (312) is not used for cooking. Therefore, the volume of usable space (310) inside this cavity is smaller than the cooking space in FIG. 3A. The ratio of usable space to total volume will also be lower.

FIG. 3C illustrates another possible existing microwave design, also known as a second conventional microwave oven (314). This microwave structure (314) has the exact same dimensions and total volume as the portable microwave oven (300, 308) in FIGS. 3A and 3B. The second conventional microwave oven (314) has an area of usable cavity space (316) on the upper (or bottom) section, while another section contains the magnetron (110), antenna (112), waveguide (114), and unused space (318). Since the total volume and orientation of the second conventional microwave oven (314) is the same as in FIGS. 3A and 3B, there is now an even larger volume of unused space (318) beside the waveguide (114). Thus, the ratio of usable space (316) to total volume will be even lower.

A real-world example of the usable space ratio calculation shows as the following: Assuming the total volume of a device is 11338 cm3; the usable space (310) ration of FIG. 3A is 84.0%; the usable space (316) ration of FIG. 3B is 76.6%; the usable space ration of FIG. 3C is 61.8%. The improvement in space efficiency in FIG. 3B has been improved by up to 36%.

Additionally, the usage efficiency of microwave energy is another issue that the design in FIG. 3A mitigates. In FIG. 3B and FIG. 3C, there is only one waveguide (114) in one direction that distributes microwaves generated by the magnetron (110) to the oven cavity space (310, 316). At the same time, the rest of the radiation is reflected internally upon the magnetron (110) due to the omnidirectional travel of microwaves. The microwaves reflect back to the magnetron (110), which is wasted and may also lead to overheating. The additional waveguides (114) lead to more cavities (302, 304, 306) in other directions, which means more microwaves can get used. This results in fewer overheating problems.

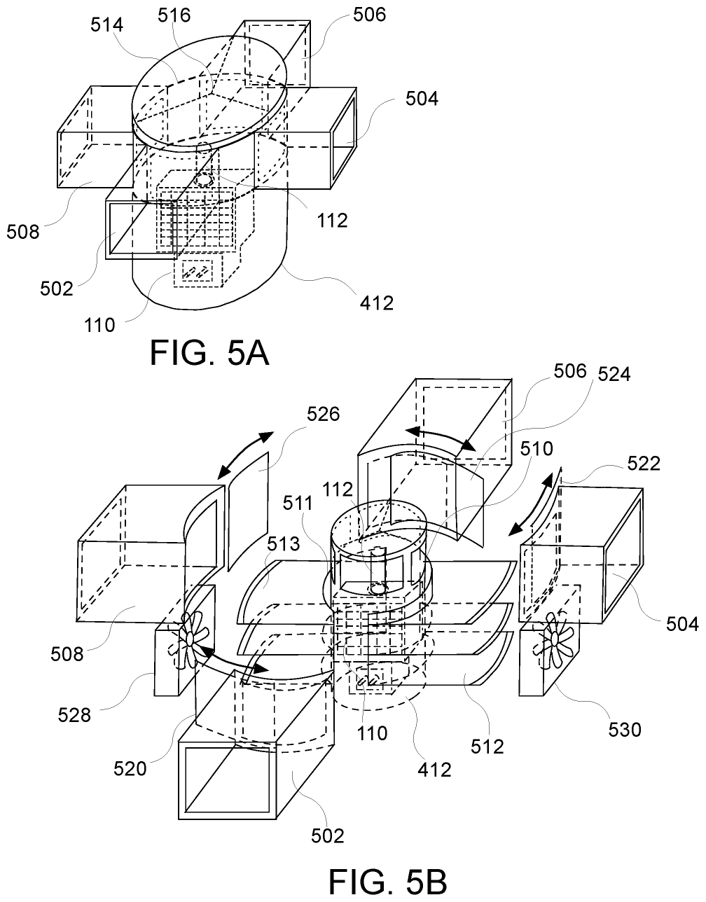

FIGS. 4A-4C illustrate the perspective and top views of the portable multi-cavity microwave oven in a few second kind embodiments of the present disclosure. FIG. 4A illustrates a perspective view of the general structure pertaining to this kind of embodiment. This embodiment is regarded as the sixth embodiment (400) of the present disclosure. The general structure of the portable microwave oven in the sixth embodiment (400) appears to be a cross shape looking from the top or bottom. A cross has four stems. Each stem of the sixth embodiment microwave oven (400) contains a separate oven cavity regarded as the first oven cavity (402), second oven cavity (404), third oven cavity (406), and fourth oven cavity (408). Each cavity is in the form of a rectangular prism. There are adjacent corner spaces (409, 410, 411, 413) between each cavity (402, 404, 406, 408): a first corner space (409) is located between the first (402) and second (404) oven cavities; a second corner space (410) is located between the second (404) and third (406) oven cavities; a third corner space (411) is located between the third (406) and fourth (408) oven cavities; a fourth corner space (413) is located between the fourth (408) and first (402) oven cavities. These corner spaces (409, 410, 411, 413) can be used to attach the functional components of the microwave oven (400); this will be explained in future paragraphs. A hollow cylindrical waveguide prism (412) is located in the center of the cross, which contains the magnetron (110) and antenna (112) that distribute microwave energy to each of the four oven cavities (402, 404, 406, 408) via waveguide branches; these branches will be explained in the paragraphs below and in FIGS. 5A-5B. Hereinafter, the term cylindrical waveguide prism (412) is interchangeable with cylindrical waveguide structure, cylindrical prism, prism, or waveguide structure. The cylindrical waveguide structure (412) only takes up a small amount of space in the center, meaning that there is more usable cavity (402, 404, 406, 408) space available. This will be further discussed in the paragraphs below and in FIGS. 5A-5B, along with a detailed view of the cylindrical waveguide prism (412).

FIG. 4B illustrates a perspective view of one of the actual product designs representing the second main kind of embodiment in the present disclosure. The handles (206) in this sub-figure are located at the top or bottom of the oven. There are four typical microwave oven doors (414), each of which seals one of the four oven cavities (402, 404, 406, 408). In the microwave oven's (400) typical orientation, the microwave oven doors (414) open outwards and close inwards along a horizontal transverse plane, as shown in the sub-figure. Each microwave oven door (414) rotates along a vertical pivot axis via the door's (414) respective hinge. The lithium-ion battery (418) can be stored under each cavity (402, 404, 406, 408). Separate compartments are attached to the general corner spaces (4409, 410, 411, 413) of the microwave oven in the sixth embodiment (400). The options for the attachments can vary according to the need. In one exemplary embodiment, the corner spaces (409, 410, 411, 413) and compartments can be arranged as the following: the first corner space (409) may have an attached LED interfaced control circuit compartment (420); the second corner space (410) may have an attached spare battery compartment (428); the third corner space (411) may have an attached power supply compartment (430); the fourth corner space (413) may have an attached empty compartment (416). The control circuit compartment (420) has a control panel (422) containing an LED display (424) and keypad (426). This control panel (422) lets the user enter and program the heating time and power level for each oven cavity (402, 404, 406, 408); the control panel (422) will be explained further in future paragraphs and in FIG. 8. Other different arrangements of the four corner attachments are possible and should be obvious to those ordinarily skilled in the art.

FIG. 4C illustrates a top view of an exemplary embodiment based on the second main kind of embodiment. The oven cavities (402, 404, 406, 408) appear to have larger surfaces extending to the corners of the microwave oven in the sixth embodiment (400). The corner spaces (409, 410, 411, 413) from FIG. 4A have become narrower, leaving little to no space between the adjacent cavities (402, 404, 406, 408). Hereinafter, this type of corner space is identified as a modified corner space or corner slit. Four corner slits (432, 434, 436, 438) are situated at each corner of the microwave oven (400) next to the oven cavities (402, 404, 406, 408): a first corner slit (432) is located between the first (402) and the second (404) oven cavities; a second corner slit (434) is located between the second (404) and third (406) oven cavities; a third corner slit (436) is located between the third (406) and fourth (408) oven cavities; a fourth corner slit (438) is located between the fourth (408) and first (402) oven cavities. In this exemplary embodiment, each cavity (402, 404, 406, 408) has more space now, making the usable space ratio even higher. The compartments (416, 420, 428, 430) shown in FIG. 4B can now be integrated under or above the microwave oven's (400) body. The cylindrical waveguide prism (412) is located in the center, which contains the magnetron (110) and antenna (112) that distribute microwave energy to each enlarged cavity (402, 404, 406, 408).

The shape of the microwave oven in the sixth embodiment (400) is shown as a cross and square, respectively. In other exemplary embodiments, the microwave oven (400) can a circular shape, octahedral shape, or any other shape that can accommodate the four oven cavities (402, 404, 406, 408).

FIGS. 5A-5B illustrate the perspective views of a preferred cylindrical waveguide/magnetron structure for the second main kind of embodiment of the present disclosure. FIG. 5A illustrates one preferred embodiment of the cylindrical waveguide structure or prism. This cylindrical waveguide prism (412) is securely kept in place in the middle of the second main kind of microwave oven embodiment, as shown in FIGS. 4A and 4C. The cylindrical waveguide prism (412) is placed in an upright orientation, where the bottom of the prism (412) touches the base of the microwave oven. A magnetron (110) is located inside the cylindrical prism (412), which generates microwave radiation. The microwave energy is then emitted by an antenna (112) above the magnetron (110) to the oven cavities via waveguide branches (502, 504, 506, 508) that protrude outwards. The cylindrical prism (412) has openings near the top of its structure to line up with the waveguide branches (502, 504, 506, 508) in order to allow microwave energy to travel to the respective oven cavity or cavities. The top interior wall of the cylindrical prism (412) has a conical protrusion (516) facing downwards towards the antenna (112) to reflect microwave energy in a more focused direction towards the waveguide branches (502, 504, 506, 508).

Four waveguide branches (502, 504, 506, 508) protrude away from the cylindrical prism (412). The waveguide branches (502, 504, 506, 508) form at 90o angles near the top of the prism (412), each is fixed in place to line up with the four oven cavities of the microwave oven in the second main kind of microwave oven embodiment, as shown in FIG. 4B: a first waveguide branch (502) lines up with the first oven cavity; a second waveguide branch (504) lines up with the second oven cavity; a third waveguide branch (506) lines up with the third oven cavity; a fourth waveguide branch (508) lines up with the fourth oven cavity. A circular band (514) is integrated with the base of each waveguide branch (502, 504, 506, 508); the circular band (514) link adjacent waveguide branches (502, 504, 506, 508) and form an integrated part to encircle the circumference of the cylindrical prism (412). So, the rear openings of the waveguide branches (502, 504, 506, 508) have top and bottom curved edges, while the front openings of the waveguide branches (502, 504, 506, 508) are straight to align with the oven cavity openings. The waveguide branches (502, 504, 506, 508) and the circular band (514) are securely fixed in place within the microwave oven. Meanwhile, the cylinder structure (412) can be rotated manually or automatically along the circular band (514) to control the distribution of microwave energy into select oven cavities. The openings of the cylindrical prism (412) line up with the rear openings of the waveguide branches (502, 504, 506, 508) to allow microwave energy to enter the respective oven cavities.

The cylindrical waveguide structure (412) addresses the microwave energy distribution efficiency issue found in conventional microwaves more effectively than the waveguide structure for the first main kind of microwave embodiment shown in FIG. 1. Because there are more waveguide branches (502, 504, 506, 508) distributed radially, fewer microwaves will be reflected and absorbed inside the magnetron (110) to be wasted as heat around the magnetron (110). Furthermore, the conical protrusion (516) helps guide microwave energy in a more focused direction to those waveguide branches (502, 504, 506, 508); this will be explained in future paragraphs and in FIG. 6.

Relating back to FIGS. 4A-4C, the waveguide branches (502, 504, 506, 508) directly connect to each oven cavity. The amount of unused space is small and ultimately limited to the area directly surrounding the cylindrical waveguide structure (412). Because of this, the usable space ratio within the microwave oven in the sixth embodiment (400) is even higher since each oven cavity can occupy a larger usable space.

The cylindrical structure (412) also can adjust cooking power levels and timing in a similar manner as the movable dividers in the first main kind of embodiment. This can be done by rotating the cylindrical structure (412), either manually with a handle or automatically with a press on the control panel's keypad. The waveguide branches (502, 504, 506, 508) and its circular band (514) are fixed in place, so they will rotate along with the entire cylindrical structure (412). In this case, the openings on the cylindrical prism (412) may not line up with the waveguide branches (502, 504, 506, 508) and their respective cavity openings. As a result, microwave energy is blocked. Therefore, in a sense, it completely cuts off the power level and stops the cooking time from any such cavity.

FIG. 5B illustrates an alternative embodiment of the cylindrical waveguide structure. The waveguide branches (502, 504, 506, 508) are fixed in place with the rear openings adjacent to the openings of the cylindrical prism (412). Like in FIG. 5A, the waveguide branches (502, 504, 506, 508) are located at the top end of the cylindrical prism (412). To control the microwave energy entering the oven cavities via waveguide branches (502, 504, 506, 508), there are shutters (520, 522, 524, 526) adjacent to the rear openings of the waveguide branches (502, 504, 506, 508) that move in directions along the horizontal transverse plane of the waveguide branches, as shown in the sub-figure as left or right of the rear openings of the waveguide branches (502, 504, 506, 508) in this particular orientation. Each shutter opens or closes a corresponding waveguide branch, which can be identified as the following: a first waveguide shutter (520) opens or closes the rear opening of the first waveguide branch (502); a second waveguide shutter (524) opens or closes the rear opening of the second waveguide branch (504); a third waveguide shutter (522) opens or closes the rear opening of the third waveguide branch (506); a fourth waveguide shutter (520) opens or closes the rear opening of the fourth waveguide branch (508). Here, the shutters (520, 522, 524, 526) are better suited for selecting a particular opening cavity to heat food.

Two heat sinks are situated on opposite ends of the cylinder prism's (412) length. Each heat sink contains a base plate (510, 511) to absorb generated heat from the magnetron (110) and a set of three straight, rectangular thermal fins (512, 513), stacked vertically in an even manner to disperse heat. Hereinafter, the general mention of the heat sink refers to both the base plates (510, 511) and thermal fins (512, 513). In this sub-figure, the heat sinks are labeled as the following: a first heat sink, containing a first base plate (510) and a first set of thermal fins (512), is located under the second waveguide branch (504); a second heat sink, containing a second base plate (511) and a second set of thermal fins (513), is located underneath the fourth waveguide branch (508). The heat sink's base plates (510, 511) are curved since they are situated along the length of the cylindrical prism structure (412) in the middle. In another sense, the base plates (510, 511) encircle the length of the prism (412). The thermal fins (512, 513) extend from the base plates (510, 511) to the walls of the respective oven cavities.

It should be noted that the locations of the heat sinks (510, 511, 512, 513) below the second and fourth waveguide branches (504, 508) are only for reference purposes. Once they are installed, the heat sinks (510, 511, 512, 513) are fixed in a given location. In another embodiment, the heat sinks ((510, 511, 512, 513) are located below the first (502) and third (506) waveguide branches, with the fins (512, 513) extending towards and connected with the walls of the first and third oven cavities. In yet another embodiment, the heat sinks (510, 511, 512, 513) can extend below all the waveguide branches (502, 504, 506, 508) to touch all the oven cavities in the second main kind of microwave oven embodiment. In this particular embodiment, a single circular heat sink (510, 511, 512, 513) would encircle the cylindrical prism (412). In a way, the base plate (510, 511) may resemble the shape of the circular band (514) in FIG. 5A.

Complementing the heat sinks (510, 511, 512, 513) are two adjacent fans on opposite ends of the microwave oven, which are facing the ends of the thermal fins (512, 513): a blowing fan (528) for blowing air to cool down the heat sinks (510, 511, 512, 513) and the prism (412); a suction (530) fan that circulates heated air away from the cylindrical structure (412) and out of the microwave oven. As indicated by the names, the air is blown and dispersed out of the microwave oven in one direction to get rid of the heat generated by reflected microwave energy.

The heat sinks (510, 511, 512, 513) further address the microwave energy distribution efficiency issue found in conventional microwaves. Specifically, the base plates (510, 511) absorb heat from the microwave magnetron (110) within the cylindrical structure (412) while the thermal fins (512, 513) distribute it away to a lower temperature medium. First, the extended length of each thermal fin (512, 513) increases the heat sink's (510, 511) overall thermal effectiveness. More heat can then be absorbed and transferred away without significantly changing the ambient temperature around the magnetron (110) and cylindrical prism (412). Second, the heat generated from reflected waves transfers to the connected oven cavities via thermal conduction. Therefore, microwave energy can be further utilized even when reflected back to the magnetron (110), even if it is through generated heat. This is key to realizing the increased efficiency of the overall energy utilization throughout the microwave oven.

The thermal fins (512, 513) presented in this sub-figure are shown to be straight fins that are rectangular in shape. In other embodiments, the thermal fins (512, 513) can be of a different type, arrangement, or shape. Such examples include flared fins and pin fins with faces of various shapes (e.g., square, circular, etc.). This is possible as long as the fins (512, 513) can fit onto the base plates (510, 511) and reach the oven cavity required for heat transfer via conduction.

Both the blowing and suction fans (528, 530) also aid in microwave energy distribution efficiency to a certain extent, allowing the transfer of thermal energy away from the heat sinks (510, 511, 512, 513) by reducing the temperature via air flow. While the heat sinks (510, 511, 512, 513) are designed to absorb and distribute heat, they are also susceptible to overheating. The fans (528, 530) work together to push such heat away from the heat sinks (510, 511) and out of the microwave oven entirely. The heat sinks (510, 511, 512, 513) can then be kept at a reasonable temperature. To that end, the thermal fins (512, 513) should be manufactured in a way that they are spaced partly sufficiently to allow sufficient air flow and maintain the efficiency of the heat sinks (510, 511, 512, 513). As the fans (528, 530) transfer heat away in a single direction, the suction fan (530) would be situated next to a vent to dispel the air to the microwave oven's outer environment. As a result of the fans (528, 530) and heat sinks (510, 511, 512, 513) working alongside each other, the magnetron (110) can absorb more reflected microwaves without overheating. In a way, the operation of both fans (528, 530) is another important factor in increasing the microwave energy distribution efficiency.

The positioning of both the blowing and suction fans (528, 530) facing the ends of the thermal fins (512, 513) is one example of positioning. In another embodiment, the fans (528, 530) can be positioned along the length of the thermal fins (512, 513), facing both the fins (512, 513) and the base plates (510, 511). The size of the fans (528, 530) may increase to dissipate heat from both heat sinks (510, 511, 512, 513) simultaneously. However, the fans (528, 530) still need to be on opposite ends of the microwave oven to allow air to flow out efficiently in one direction.

All the mechanical controls, adjustments, and rotation with movable dividers, waveguide prism, cavities, and door control are described as being controllable via manual or automatic means. Such automatic means include electrical motor driving, software programming control, AI control, remote control, and any other control solutions.

FIG. 6A illustrates a front view of the waveguide structure (114) in the first main kind of embodiment, while FIG. 6B illustrates a top view of the same. All descriptions of the magnetron (110), antenna (112), waveguide structure (114), waveguide openings (116, 117), and angled protrusion (128) from FIG. 1 also apply here. FIG. 6A and FIG. 6B also illustrate the microwave energy (602) and its direction (604) towards the waveguide openings (116, 117). FIG. 6C illustrates a front view of the cylindrical waveguide structure (412) in the second main kind of embodiment, while FIG. 6D illustrates its top view. All descriptions of the magnetron (110), antenna (112), waveguide branches (502, 504, 506, 508) from FIGS. 5A-5B also apply here. FIG. 6C shows one view of the cylindrical waveguide structure (412) with the second waveguide branch (504) and the fourth waveguide branch (508) at opposite ends. FIG. 6C and FIG. 6D also illustrate the microwave energy (602) and its direction (604) towards the waveguide branches (502, 504, 506, 508). The waveguide structure (114) from the first main kind of embodiment also has a conical protrusion at the top of the waveguide's (114) interior. This is akin to the second kind of embodiment's conical protrusion (516), in which it helps further guide microwave energy (602) through the waveguide's chamber to the adjacent cavity.

The waveguide structures (114, 412) in both kinds of embodiments are typically made of metal with low bulk resistivity, including brass, copper, silver, aluminum, etc. As the sub-figures illustrate, all the waveguide structures (114, 412) have a hollow interior that allows microwaves (602) to reflect off the interior walls of the waveguide structures (114, 412). This way, the waveguides (114, 412) can travel in specific directions (604) to the oven cavities without losing power during propagation. The inner walls may have a coating of silver or gold. Because little power is lost, more microwave energy (602) can be quickly transmitted and are available to heat food inside the cavity.

While microwave energy (602) is shown to travel in a specific direction (604), the waves (602) also reflect off the inner walls surrounding the magnetron (110). In the second main kind of embodiment, it is within the cylindrical structure (412). As noted earlier, the cylindrical waveguide structure (412) with multiple waveguide branches (502, 504, 506, 508) allows more microwave energy (602) to travel away from the magnetron (110) to the respective oven cavities. This is key to optimize microwave energy (602) usage and distribution. Furthermore, the positioning of the waveguides (114, 412) relative to their respective microwave oven allows for a better space usage ratio compared to other conventional microwave designs.

Both FIG. 6A and FIG. 6C illustrate a protrusion (128, 516) at the top of their respective waveguide structures (114, 512). Although the waveguide structures (114, 412) already guide the microwave energy (602) towards the oven cavities, the waves (602) still bounce around within the waveguide structures (114, 412). Due to their omnidirectional movement, microwaves (602) can also reflect back to the magnetron (110) from the top of the respective structures (114, 412). The protrusions (128, 516) increase the microwave energy (602) distribution efficiency further by providing an additional reflective surface for guiding microwave energy (602) into the waveguide openings (116, 117) or branches (502, 504, 506, 508). Furthermore, the cylindrical structure (412) is less likely to overheat due to reflection back to the magnetron (110).

The protrusions (128, 516) are shaped according to the shape of the respective waveguide structure (114, 412). Both protrusions (128, 516) in the sub-figures are angled in a way that most efficiently direct microwave energy (602) into the respective waveguide openings (116, 117) or branches (502, 504, 506, 508); however, other embodiments may have protrusions in different sizes and angling depending on the manufacturer. The important aspect here is the protrusion (128, 516) shape itself.

In the first main kind of embodiment, the waveguide structure (114) is shaped as a rectangular prism with flat faces. As a result, the angled protrusion (128) has flat rectangular faces angling downwards within the hollow interior of the waveguide structure (114). The rectangular faces are angled in a way that mirrors one another to reflect microwaves (602) towards both waveguide openings (116, 117). In a sense, the angled protrusion (128) also acts as a distinct indicator that identifies the first and second waveguide openings (116, 117). In the second main kind of embodiment, the cylindrical waveguide structure (412) is a cylinder shape, as the name implies. As a result, a cone-shaped protrusion or conical protrusion (516) with a circular base is formed at the top of the cylindrical waveguide structure (412). The cone's smooth and unbounded surface optimally uses the microwave energy's (602) omnidirectional nature to radially distribute that energy to the waveguide branches (502, 504, 506, 508).

FIG. 7 illustrates an exemplary general operational flowchart for two preferred main kinds of embodiments of the portable multi-cavity microwave oven in the present disclosure. The operation starts (702) with the oven power turned on (704). The user can open the microwave oven door (706) to place their food inside. If there is a need to adjust the cavity space (708) before placing food inside, the user adjusts the movable dividers (710). The user closes the microwave door at (712). Before step (706), if food has already been placed inside the cavity, the user can go directly from (704) to set the cooking parameters at step (714) on the control panel. The user presses the start button at (716). From there, certain safety sensors determine if the system condition is okay (718). If the system condition is okay, then the microwave oven begins heating (720) using the set parameters (714). At step (722), the oven examines whether heating time has been reached. If so, the heating stops at (724). The system deactivates (726), and the overall operation ends (728). Suppose the heating time has not expired at step (722), the control circuit checks if the system condition is satisfactory (718). If yes, the oven will continue heating the food until the timer expires at (722). If the system condition is not considered okay at step (718), a safety shut-off (730) is activated, and oven operation stops. From there, the user needs to inspect the microwave oven for the cause of the safety shut-off (730). First, the user checks for any illegal parameters (732) set on the control panel. For example, the user may have set a time unacceptable to the control unit. If so, the user must reset the parameters on the control panel to set a new appropriate parameter (714). Otherwise, the user checks if all doors were properly closed (734). If not, the user must close that door (712). Otherwise, the user checks the battery at step (736). If the battery is low or insufficient, the user must replace the battery, use a power cable, or, in the case of the second main kind of embodiment, the appropriate external power compartment at step (738). From there, the user must turn the power back on at (704). Otherwise, a more complicated repair (740) must be done. From there, the process then ends at (728). It should be noted that the opening (706) and closing (712) of the microwave door, as well as the adjustment of movable dividers (710), are optional. As long as the microwave oven door is sealed, the user can directly start at step (714) after turning the power on (704). It should also be noted that the problems listed in steps (732), (734), and (736) are examples of problems that the average user can fix; however, they are not the only reasons why a safety shut-off (730) can occur, nor do they have to be inspected in the order shown in the figure. Skilled users may be able to fix more complicated problems during the repair (740) stage, or it can be sent to the manufacturer. The steps illustrated in FIG. 7 are only for the purpose of providing a basic workflow and a list of basic steps. It should not serve the purpose of limiting the operation steps to the listed, nor should it disallow skipping or replacing any steps. Advanced microwave operations can always be developed and incorporated.

FIG. 8 illustrates a general system block diagram of the typical system components for two preferred main kinds of embodiments of the portable multi-cavity microwave oven in the present disclosure. The figure mostly illustrates at a high level how such a portable multi-cavity microwave oven (100, 200, 300, 400) can be implemented. As a result, many of the components, such as oven cavities (102, 104, 106, 402, 404, 406, 408), magnetron (110), waveguides (114, 412), etc., have descriptions from previous figures that can apply here.

In addition, the cooling component can either be the cooling unit (122) and cooling fan (124) from the first main kind of embodiment or the heat sinks (510, 511, 512, 513) and blowing/suction fan pairs (528, 530) from the second main kind of embodiment. Both kinds of embodiments can also interact with temperature sensors (810) that are considered a type of safety sensor (824). The temperature sensors (810) can be placed throughout the portable microwave oven. When the microwave oven (100, 200, 300, 400) gets heated at a certain temperature, it communicates with the control unit (126, 420) to modify the duty cycle of the microwave oven (100, 200, 300, 400) operation and pause or stop heating. The microwave oven (100, 200, 300, 400) has a power supply (126, 430) that comprises multiple components. The power supply (126, 430) is responsible for providing energy to the whole microwave oven unit (100, 200, 300, 400) via an external power source such as a rechargeable battery (120, 418, 428) or a direct AC power outlet (802). The power supply (126, 430) contains a power converter/transformer (804) and capacitor (806). The power converter/transformer (804) transforms the voltage from an external power source to an extremely high voltage required for a typical magnetron (110) to operate. The capacitor (806) is used to stabilize and smooth out the converted voltage. The diode (808) is also used for rectifying the alternating current to direct current. If the microwave oven (100, 200, 300, 400) is plugged in, the AC detection (818) component of the control circuit (126, 420) detects the presence of AC power (802). If no AC power (802) is detected, the microwave oven (100, 200, 300, 400) operates through a DC power source (i.e., the rechargeable battery (120, 418, 428)). If there is no battery (120, 418, 428) or the battery (120, 418, 428) is too low, the oven (100, 200, 300, 400) stops its operation. The rechargeable battery (120, 418, 428) and direct AC power (802) are considered more common power sources for the microwave oven (100, 200, 300, 400). In an alternative embodiment, other power sources, such as a car plug, can be used to power the microwave oven (100, 200, 300, 400). In yet another alternative embodiment, the power supply (126, 430) can be an inverter.

The control unit (126, 420) contains several components, including a processor (812) and memory (814). The memory (814) can be a readable medium such as RAM, ROM, flash memory, etc. The components can be discrete components or integrated as part of a rigid or flexible circuit board. It also includes an AC detection component (818) that communicates with the battery (120, 418, 428) to detect and use AC power (802). The AC detection component (818) also communicates with the power converter/transformer (804) to determine and regulate input voltage. There is also a safety switch (822) that switches the microwave oven (100, 200, 300, 400) off if the safety sensors (824) determine any dangerous conditions for operation. The input/output circuitry (820) contains any IO ports and interfaces (e.g., USB, Bluetooth, Ethernet port, Wi-Fi, audio 10, VGA port, HDMI, CAN bus, etc.). The input/output circuitry (820) also analyzes any signals throughout the microwave oven (100, 200, 300, 400), such as the output from the safety sensors (824) and safety switch (822), while communicating with the processor (812) and memory (814). The control panel (422), which is connected to the control unit (126, 420), includes an LED display (424) and the keypad (426) for user interfacing to select parameters (426) such as cooking time, clock set, oven start, oven stop, reset, etc. The display controller (816) is instructed by the processor (812) and memory (814) to visually display information on the LED display (424). This can include cooking time or error messages. In other embodiments, the LED display (424) can be replaced with other displays such as an LCD, ELD, or plasma. In yet another embodiment, the entire control panel (422) can be a touch screen display linked to the display controller (816).

In an exemplary embodiment, the control unit (126, 420) can be modified to select heating oven cavities (102, 104, 106, 402, 404, 406, 408) for both main kinds of embodiments. Instructions from the processor (812) and memory (814) can be adjusted to select the desired heating cavity (102, 104, 106, 402, 404, 406, 408) via the control panel (422). This may be extended to allow automatic adjustments of the movable dividers in the first main kind of embodiment or the cylindrical waveguide structure's rotation in the second main kind of embodiment. In the second variant of the second main kind of embodiment, it would involve adjusting the movable shutters for each waveguide branch. The safety sensors (824) communicate with the safety switch (822) to detect an unsafe condition during microwave oven (100, 200, 300, 400) use. This communication is done through the control unit (126, 420) from the input/output circuitry (820) to the processor (812) and memory (814). The safety switch (822) then cuts the power off until the issue is resolved. Once resolved, the sensors (824) detect the given parameters to determine if the oven (100, 200, 300, 400) is safe to use. Some common sensors (824) incorporated with the microwave oven (100, 200, 300, 400) include, but are not limited to: tactile-based gravity sensors, temperature sensors (810), door seal sensors, etc. In another embodiment, a beep sound can be incorporated as part of the safety shut-off to notify users with a distinct sound.

1. A portable microwave apparatus with a heating chamber, comprising:
a generator in the center of the oven or chamber that generates microwaves for heating;
a first cavity occupying a first part of the chamber that is on one side of the generator;
a second cavity occupying a second part of the chamber that is on another side of the generator;
wherein at least under one condition, the first cavity is separated from the second;
a waveguide installed between the generator and cavities that direct the microwaves from the generator into the cavities through a first and second waveguide opening;
wherein a first portion of the generated microwave energy enters the first cavity for heating through the first waveguide opening;
wherein a second portion of the generated microwave energy enters the second cavity for heating through the second waveguide opening;
wherein at least one of the first and second portions of the generated microwave energy can be adjusted;
wherein the portable microwave oven is light, compact, and can be powered by a battery;
wherein the simultaneous heating in the first and second cavities improves cooking efficiency and capability.

2. The apparatus of claim 1, wherein the microwave generator has an antenna to transmit the microwaves in the waveguide from the waveguide openings; wherein the generator is a magnetron.

3. The apparatus of claim 1, wherein the separation between the first and second cavities is spatial, thermal, and/or electrical; wherein the spatial separation means there is no shared space between the first and second cavities; wherein the electrical separation means there is no electromagnetic field in the first cavity that can enter the second cavity and vice versa.

4. The apparatus of claim 1, wherein the adjustment can be zero, one hundred, or any percentage in between; wherein the first and second portions of the generated microwaves can be adjusted respectively and independently; wherein the adjustment may be automatic without human intervention.

5. The apparatus of claim 1, further comprising a horizontal cavity occupying a horizontal part of the chamber that is on a horizontal side of the generator; wherein this horizontal part of the chamber connects the first and second parts of the chamber; wherein the horizontal cavity may have a first shared space with the first cavity and/or a second shared space with the second cavity; wherein the horizontal cavity can be at the top or bottom of the oven for improved spatial utilization efficiency.

6. The apparatus of claim 5, wherein the opening between the first or second shared space to a non-shared space in either the first or horizontal cavity can be adjusted from zero, one hundred, or any percentage in between; wherein the horizontal cavity may contain a supporting structure in the first and second shared spaces to support the object to be heated.

7. The apparatus of claim 6, wherein the heating starting time, ending time, duration, and/or microwave power of at least the first, second, and/or horizontal cavity can be configured differently and independently; wherein the cavities may have cavity doors for opening and closing individually or together around appropriate hinges.

8. The apparatus of claim 1, further comprising a third cavity occupying a third part of the chamber that is on a third side of the generator; a fourth cavity occupying a fourth part of the chamber that is on a fourth side of the generator; and so on and so forth; wherein all cavities are disjoint and separated from each other; wherein a third portion of the generated microwave energy enters the third cavity for heating through a third waveguide opening and a fourth portion of the generated microwave energy enters the fourth cavity for heating through a fourth waveguide opening.

9. The apparatus of claim 8, wherein the first, second, third, and fourth cavities can be rotated around the generator; wherein the first, second, third, and fourth waveguide openings can be adjusted to be zero, one hundred, or any percentage in between; wherein the adjustment may be automatic without human intervention.

10. The apparatus of claim 8, wherein the first, second, third, and fourth portions of the generated microwaves can be adjusted respectively and independently; wherein the adjustment can be zero, one hundred, or any percentage in between; wherein the adjustment may be automatic without human intervention; wherein the heating in the first, second, third, and fourth cavities can be at the same time.

11. The apparatus of claim 8, further comprising a first compartment that is located between the first and second cavities; a second compartment that is located between the second and third cavities; a third compartment that is located between the third and fourth cavities; a fourth compartment that is located between the fourth and first cavities; wherein at least one compartment may have zero volume.

12. The apparatus of claim 11, wherein each compartment has a different size and may store or install various microwave components such as a control circuit, electrical components, spare battery, or nothing.

13. The apparatus of claim 1, further comprising heat sink fins that thermally connect the generator to the shell of at least one cavity to dispel the heat more efficiently and possibly reuse of the heat.

14. The apparatus of claim 13, further comprising at least a pair of fans installed on opposite sides of the heat sink to blow in and draw out air for more efficient cooling; a carrying handle may be installed at the top and/or side of the oven.

15. A method for improving efficiency and functionality of a portable microwave oven with a cooking chamber, comprising:
providing a generator in the center of the oven or chamber that generates microwaves for heating;
providing a first cavity occupying a first part of the chamber that is on one side of the generator;
providing a second cavity occupying a second part of the chamber that is on another side of the generator;
wherein at least under one condition, the first cavity is separated from the second;
providing a waveguide installed between the generator and cavities that direct the microwave from the generator into the cavities through a first and second waveguide opening;
wherein a first portion of the generated microwave energy enters in the first cavity for heating through the first waveguide opening;
wherein a second portion of the generated microwave energy enters in the second cavity for heating through the second waveguide opening;
wherein at least one of the first and second portions of the generated microwave energy can be adjusted;
wherein the portable microwave oven is light, compact, and can be powered by a battery;
wherein the simultaneous heating in the first and second cavity improves cooking efficiency and capability.

16. The apparatus of claim 15, wherein the separation between the first and second cavities is spatial, thermal, and/or electrical; wherein the spatial separation means there is no shared space between the first and second cavities; wherein the electrical separation means there is no electromagnetic field in the first cavity that can enter the second cavity and vice versa; wherein the adjustment can be zero, one hundred, or any percentage in between; wherein the first and second portions of the generated microwave can be adjusted respectively and independently; wherein the adjustment may be automatic without human intervention.

17. The method of claim 15, further comprising providing a horizontal cavity occupying a horizontal part of the chamber that is on a horizontal side of the generator; wherein this horizontal part of the chamber connects the first and second parts of the chamber; wherein the horizontal cavity may have a first shared space with the first cavity and/or a second shared space with the second cavity; wherein the horizontal cavity can be at the top or bottom of the oven for improved spatial utilization efficiency.

18. The method of claim 15, further comprising providing a third cavity occupying a third part of the chamber that is on a third side of the generator; providing a fourth cavity occupying a fourth part of the chamber that is on a fourth side of the generator; and so on and so forth; wherein all cavities are disjoint and separated from each other; wherein a third portion of the generated microwave energy enters the third cavity for heating through a third waveguide opening and a fourth portion of the generated microwave energy enters the fourth cavity for heating through a fourth waveguide opening.

19. The method of claim 17, wherein the heating starting time, ending time, duration, and/or microwave power of at least the first, second, and/or horizontal cavity can be configured differently and independently; wherein the heating in the first, second, and horizontal cavities can be at the same time.

20. The method of claim 15, further comprising providing heat sink fins that thermally connect the generator to the shell of at least one cavity dispel the heat more efficiently and possibly reuse the heat; providing at least a pair of fans installed on opposite sides of the heat sink to blow in and draw out air for more efficient cooling; providing a carrying handle that may be installed at the top and/or side of the oven.
